(19) United States
(12) Patent Application Publication
(10) Pub. No.: US 2017/0002959 A1
(43) Pub. Date: Jan. 5, 2017

(54) CONNECTOR INCLUDING A CRIMPED LOCKING RING AND METHOD FOR CRIMPING SUCH A LOCKING RING

(71) Applicant: SOURIAU, VERSAILLES (FR)

(72) Inventor: GUILLAUME SECLET, CONNERRE (FR)

(21) Appl. No.: 15/190,887

(22) Filed: Jun. 23, 2016

(30) Foreign Application Priority Data
Jun. 30, 2015 (FR) 15 56150

(51) Int. Cl. F16L 13/14

(52) U.S. Cl. CPC F16L 13/141

(57) ABSTRACT

A connector includes a crimped locking ring and a plug body. The crimped locking ring surrounds the plug body. The connector further includes two roller burnishing half washers positioned in a groove of the plug body. Each roller burnishing half washer includes a groove on its external cylindrical surface. The groove of the roller burnishing half washers cooperates with a roller with a shape that complements the groove to crimp the locking ring.

### TECHNICAL FIELD OF THE INVENTION

This invention relates to a connector comprising a crimped locking ring and a method for crimping such a locking ring. In particular, it applies to the crimping of a locking ring on the body of a connector plug.

### STATE OF THE ART

FIG. 1 relating to the prior art shows the crimping of a locking ring 11 on a plug body. Crimping is achieved by means of the plastic deformation of the end of said ring, during an operation similar to roller burnishing using a roller 12, acting as a punch, and a tool in two parts 14, 11 acting as a die, wherein one of the two parts 14, known as the roller burnishing washer, remains captive between the locking ring and the plug body 10 after the crimping operation.

The locking ring 11 is assembled in the following steps:

the single-piece roller burnishing washer 14 is positioned on the plug body, supported by a shoulder,

the standard tool 13 is moved up to the roller burnishing washer 14,

the roller 12 is applied to the surface of the locking ring 11,

the part is made to rotate by moving the roller towards the axis of rotation of the part until it reaches a mechanical stop.

However, some plug bodies have an integrated fitting with the particularity of having a larger rear part. In that case, a standard tool as described above cannot be used to crimp the locking ring because of the configuration of the plug body, because the single-piece roller burnishing washer cannot be introduced from the rear. Further, the use of a standard tool carries a risk of damaging a certain number of pieces (e.g. incorrect calibration of the standard tool). That leads to production scrap.

OBJECT OF THE INVENTION

The invention aims to remedy these drawbacks.

To that end, in a first aspect, this invention relates to a connector including a crimped locking ring and comprising:

a plug body,

a crimped locking ring surrounding said plug body,

two roller burnishing half washers positioned in a groove of the plug body and comprising a groove on their external cylindrical surface, wherein the groove of the roller burnishing half washers cooperates with a roller with a shape that complements the groove to crimp the locking ring.

Those arrangements make it possible to crimp a connector with an integrated fitting, which is impossible using the technique of the prior art.

The groove is located on the external cylindrical surface of each half washer (that is to say the outer wall).

Doing away with the crimping tool helps reduce scrap. In a second aspect, the invention relates to a method for crimping a locking ring on the connector according to the invention, which method comprises the following steps:

the two roller burnishing half washers, the external cylindrical surface of which comprises a groove, are positioned in a groove of the plug body,

the locking ring is moved up to the stop of the plug body above the roller burnishing half washers,

the locking ring is crimped by a roller that deforms the end of said ring in the groove of the roller burnishing half washers

the two roller burnishing half washers (15) are held by assembling each end of the roller burnishing half washers (15) using a holding element.

In one embodiment, the locking ring is inserted from the front of the plug body.

In one embodiment, the locking ring is inserted from the rear of the plug body.

In one embodiment, the method comprises a step for holding the two roller burnishing half washers by assembling each end of the roller burnishing half washers.

### BRIEF DESCRIPTION OF FIGURES

Other benefits, aims and characteristics of this invention will become apparent in the description below, which is explanatory and not limitative in any way, by reference to the drawings attached, wherein:

FIG. 1 (relating to the prior art) is a diagram of the mounting of a locking ring along a transverse section,

FIG. 2 is an exploded view of an assembly with two halves of a burnishing roller washer in a particular embodiment of the connector according to this invention,

FIG. 3 is a mounting diagram along a transverse plane at the time when the locking ring is crimped in a particular embodiment of the connector according to this invention,

FIG. 4 is a logical diagram of the steps used in a particular embodiment of the method according to this invention,

FIG. 5 is a drawing of a mounting step before the assembly of the two roller burnishing half washers,

FIG. 6 is a drawing of a mounting step after the assembly of the two roller burnishing half washers.

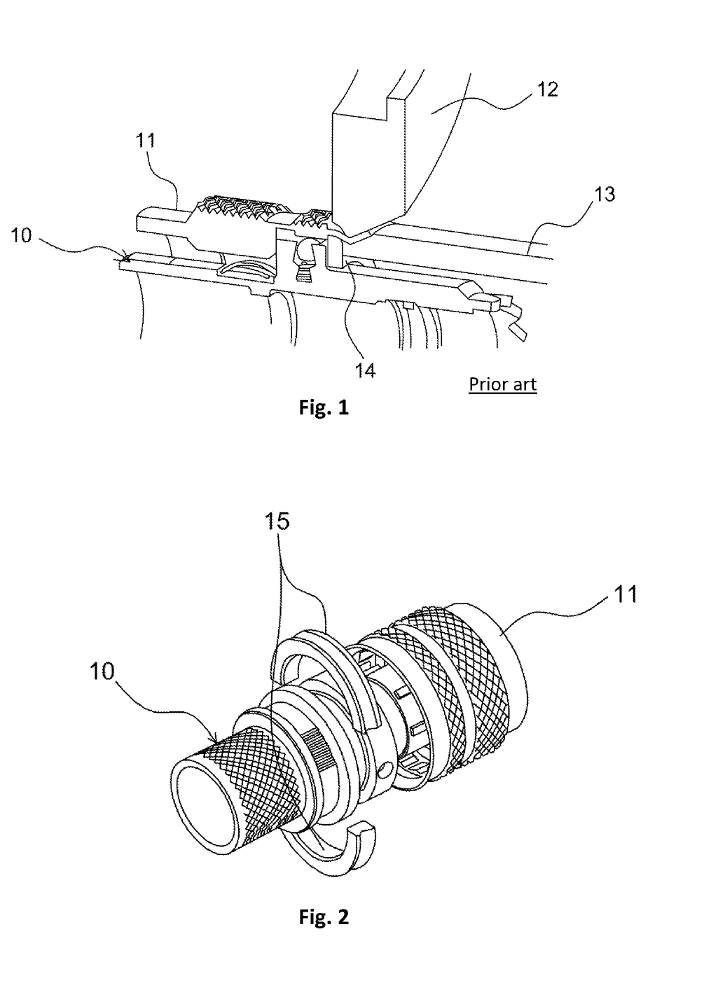

### DESCRIPTION OF EXEMPLARY EMBODIMENTS OF THE INVENTION

FIG. 2 is an exploded view of an assembly with two halves of a roller burnishing washer 15.

It shows a plug body 10 comprising a groove in which the two burnishing roller half washers 15 are positioned. Each half washer is placed in a groove of the plug body 10. The rake makes it possible to keep the two half washers 15 concentric in relation to the center line of the plug body 10. The locking ring is positioned around the plug body 10.

The term ‘groove’ means a cylindrical kerf extending over the entire circumference of a cylindrical surface.

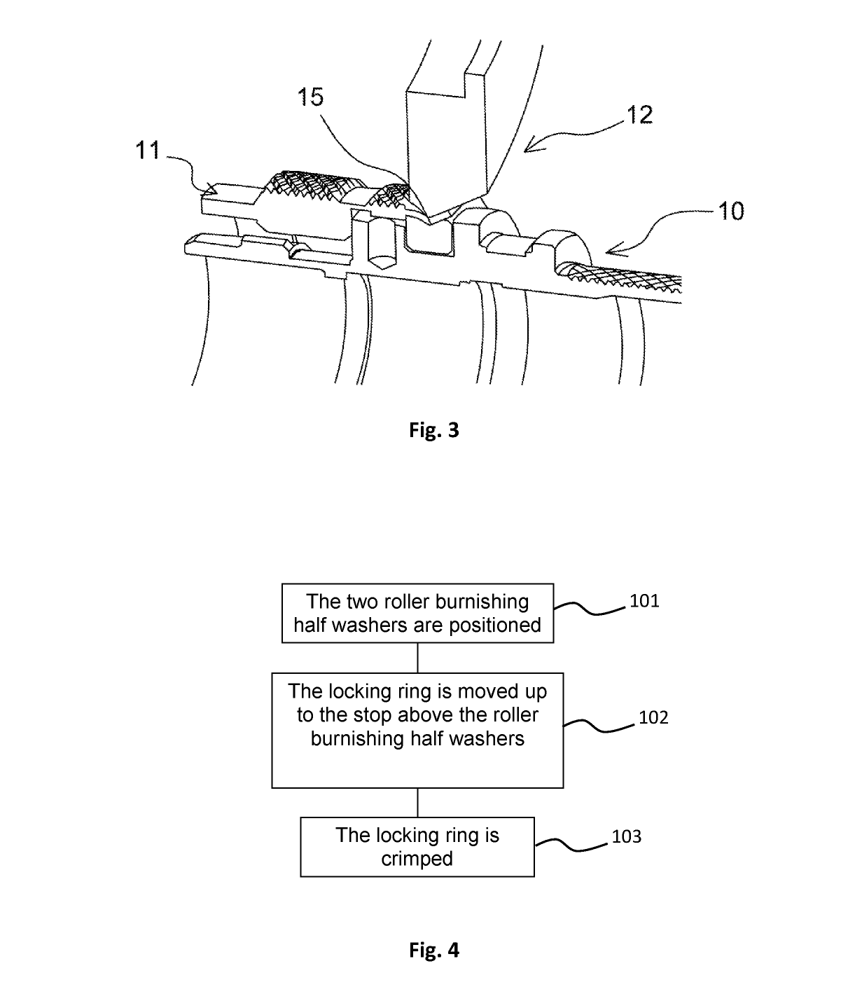

FIG. 3 is a mounting diagram at the time of the crimping of the locking ring 15.

It shows a plug body 10, a roller 12 for crimping the locking ring 11, half a roller burnishing washer 15.

Each half of the roller burnishing washer 15 comprises a groove that is suitable for cooperating with the roller 12 to crimp the locking ring 11.

The groove of the roller burnishing half washers 15 is, for example, U, V or W shaped, without these examples being limitative, and acts as a die in relation to the plastic deformation of the locking ring. The shape of the roller 12 complements that of the groove of the roller burnishing washer and cooperates with it to transfer that profile to the locking ring 11 by plastic deformation. The roller burnishing half washers remain captive in the connector after the crimping operation. The roller burnishing half washers act as guides for the crimping operation.

FIG. 4 is a logical diagram of the assembly of the locking ring 15:

in a positioning step 101, the two roller burnishing half washers 15 are positioned in a plug body groove,

in a pre-assembly step 102, the locking ring is moved on the plug body up to the stop, above the roller burnishing half washers 15,

in a crimping step 103, the portion of the locking ring 11 located above the roller burnishing half washers is deformed in the groove of the roller burnishing half washers (15).

The locking ring 11 is inserted via the front of the plug body 10. The idea of insertion from the front is determined by the fact that the front face is the coupling face with the antagonistic connector called the fixed connector, characterized by the presence of fool-proofing elements and electrical contacts.

In another example, the locking ring is inserted via the rear face. The rear face is defined as that opposed to the front surface.

In one exemplary embodiment, the plug body comprises knurling on the rear part.

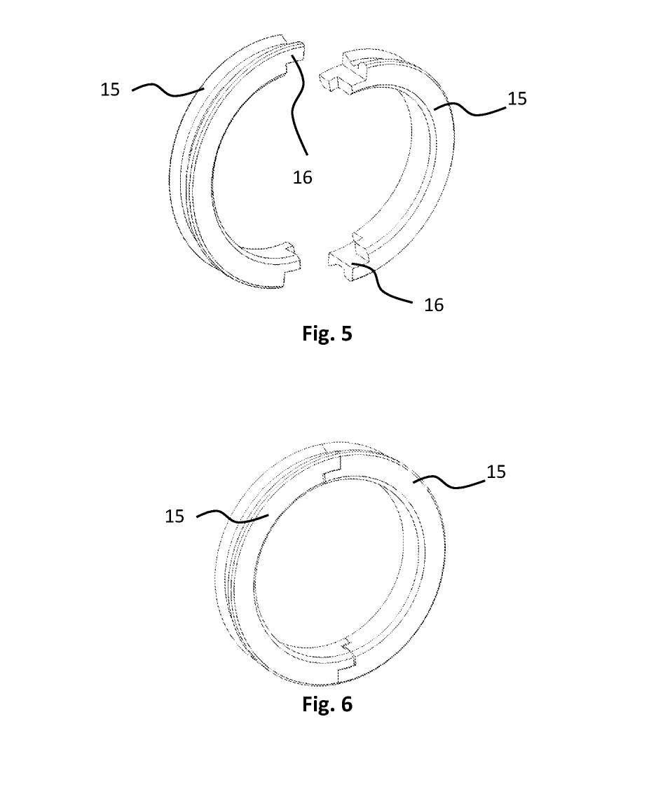

FIG. 5 is a pre-assembly step of the two roller burnishing half washers 15. In this exemplary embodiment, each roller burnishing half washer 15 has a holding element.

In the example shown, one roller burnishing half washer 15 has a male protuberance (like an appendix) and the other roller burnishing half washer 15 has a female protuberance.

FIG. 6 represents the assembly of the two roller burnishing half washers 15. It shows that the assembly makes it possible to hold the two roller burnishing half washers 15 in position by forming centering while preventing one half washer from slipping in relation to the other.

In another example, the two roller burnishing half washers 15 are assembled by a magnetic element positioned at each end of the roller burnishing half washers.

In another example, the two roller burnishing half washers 15 are assembled by clipping.

The two half washers are assembled by all types of element that can center one roller burnishing half washer 15 in relation to the other.

### LIST OF PARTS

10 plug body
11 locking ring
12 roller
13 holding tool
14 roller burnishing washer
15 roller burnishing half washer

1-4. (canceled)

5. A connector comprising:
a plug body;
a crimped locking ring surrounding the plug body;
two roller burnishing half washers positioned in a groove of the plug body and comprising a groove on their external cylindrical surface, wherein the grooves of the two roller burnishing half washers cooperate with a roller with a shape that complements the grooves of the two roller burnishing half washers to crimp the crimped locking ring.

6. A method for crimping a locking ring of a connector comprising a plug body and two roller burnishing half washers, comprising the steps of:
positioning the two roller burnishing half washers in a groove of the plug body of the connector, an external cylindrical surface of each roller burnishing half washer comprises a groove;
moving the locking ring up to a stop of the plug body above the roller burnishing half washers;
crimping the locking ring by a roller that deforms an end of the locking ring in the grooves of the two roller burnishing half washers; and
holding the two roller burnishing washers by assembling each end of the two roller burnishing half washers using a holding element at said each end.

7. The method according to claim 6, further comprising the step of inserting the locking ring from front of the plug body.

8. The method according to claim 6, further comprising the step of inserting the locking ring from rear of the plug body.
